(19) United States
(12) Patent Application Publication
(10) Pub. No.: US 2011/0148268 A1
(43) Pub. Date: Jun. 23, 2011

(54) Method for Spill Containment and Shelves or the Like Therefore

(75) Inventors: John Patrick Driver, Henryville, IN (US); Matthew McMillin, Palmyra, IN (US); Bradley M. Nall, Elizabethtown, KY (US)

(73) Assignee: SSW HOLDING COMPANY, INC., Fort Smith, AR (US)

(21) Appl. No.: 13/000,487

(22) PCT Filed: Jun. 26, 2009
(86) PCT No.: PCT/US2009/048775

§ 371 Date: Mar. 11, 2011

Related U.S. Application Data
(60) Provisional application No. 61/133,273, filed on Jun. 27, 2008.
(60) Provisional application No. 61/216,540, filed on May 18, 2009.

(51) Int. Cl. F25D 25/02; A47B 96/02; B05D 3/02

(52) U.S. Cl. 312/408; 211/134; 427/193

(57) ABSTRACT

The specification discloses a method for containing spills on shelving and the like, and the resulting support members made in accordance with the method, by providing the generally flat top surface of a support with a hydrophobic surface which is arranged in a spill containment pattern and which is generally in the plane of the top surface of the support. The majority of the top surface of the support consists of one or more spill containment areas which are of a non-hydrophobic nature and which are bounded by the hydrophobic surfaces, such that spills on the shelving collect in the non-hydrophobic spill containment area or areas and are prevented from spreading by the hydrophobic surfaces.

### CROSS-REFERENCE TO RELATED APPLICATIONS

This application claims priority to U.S. provisional patent application Ser. No. 61/133,273 entitled HYDROPHOBIC SHELF, filed Jun. 27, 2008, and to U.S. provisional patent application Ser. No. 61/216,540, entitled Hydrophobic Shelf With Ceramic Frit, filed May 18, 2009.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

The invention relates to shelving and the like, e.g., countertops and table tops, including shelving which may be adapted for use with refrigerators. More particularly, the invention relates to the support surfaces of such articles which have spill containing features.

2. Background Art

Previous types of shelving have been developed for use as refrigerator and other shelves. Shelving designs exist in the prior art which include means for containing liquid spills and leaks from a container stored on a shelf, and preventing the spill from dripping from the shelf onto the floor or into other parts of a refrigerator, commonly referred to as “spill proof” shelving. For example, Kane, et al., U.S. Pat. No. 5,564,809, issued Oct. 14, 1996, discloses a shelf assembly with a shelf panel, a shelf support supporting the panel and a molded one-piece member encapsulating the edge of the shelf panel and a substantial majority of the shelf support.

Herrmann, et al., U.S. Pat. No. 5,735,589, issued Apr. 7, 1998, discloses a shelf panel for a refrigerator compartment which includes a shelf panel which is slidably supported for extension and retraction on a support, and which includes slide members which are preferably molded so as to form a rim on an the top article support surface of the shelf panel to contain liquids.

Bird, et al., U.S. Pat. No. 5,429,433, issued Jul. 4, 1995, also describes a refrigerator shelf which is adapted for containment of spills on the shelf. The shelf includes a planer shelf with a rim molded around the perimeter edge of the shelf, which projects above the top surface of the shelf to form a dam for containing liquid spills on the shelf.

Meier, et al., U.S. Pat. No. 6,120,720, issued Sep. 19, 2000, discloses a method of manufacturing a glass shelf with a plastic edge for retaining spills on the shelf. The glass shelf panel is placed in a cavity of a mold and plastic material is injected into mold cavities surrounding the glass shelf panel such that a plastic edging is formed around the perimeter of the glass shelf panel.

Additional techniques for containing spills in refrigerator shelving include the use of injection molded plastic, so as to encapsulate a support plate forming the shelf, using plastic molded parts to essentially “sandwich” a support plate between the parts, or using a silicone sealant or various other types of adhesives to form physical spill containment barriers around the perimeter of the refrigerator shelving. In addition to the foregoing, it is known to utilize formed lips or ridges on the surface of the support plate, so as to essentially provide a physical barrier as a liquid retention feature.

### SUMMARY OF THE INVENTION

The present invention is a method for containing spills on shelving and the like having a support top surface, and the resulting items made in accordance with the method, by providing the support top surface with a hydrophobic surface which is arranged in a spill containment pattern and which is generally in the plane of the top surface of the support. The majority of the top surface of the support consists of one or more spill containment areas which are of a non-hydrophobic nature and which are bounded by the hydrophobic surfaces, such that spills on the surface collect in the non-hydrophobic spill containment area or areas and are prevented from spreading by the hydrophobic surfaces.

These and other objects, advantages and features of the invention will be more fully understood and appreciated by reference to the Description of the Preferred Embodiments, and the appended drawings.

### BRIEF DESCRIPTION OF THE DRAWINGS

Preferred embodiments of the invention will now be described with reference to the drawings, in which:

FIG. 1 is a perspective view of a prior art shelf assembly, utilizing the concept of encapsulation of a shelf for providing spill containment features;

FIG. 2 is a front, sectional view of the shelf assembly shown in FIG. 1, with the absence of the side support arms;

FIG. 3 is a perspective view of a shelf assembly in accordance with a preferred embodiment of the invention with a hydrophobic surface spill containment pattern on the top surface so as to provide for a spill-containing shelf;

FIG. 4 is a front, elevation view of the shelf assembly shown in FIG. 3, with the absence of the side support arms;

FIG. 5 is a perspective view of an alternative embodiment shelf having a different hydrophobic surface spill containment pattern; and

FIG. 6 is a perspective view of an alternative embodiment shelf having yet another different hydrophobic surface spill containment pattern.

### DESCRIPTION OF THE PREFERRED EMBODIMENTS OF THE INVENTION

In the preferred embodiments, the term “shelving and/or the like,” or “shelf and/or the like” encompasses shelves and articles whose top surfaces serve similar functions, such as countertops and table tops. Certain embodiments are especially advantageous for use in refrigerator shelving.

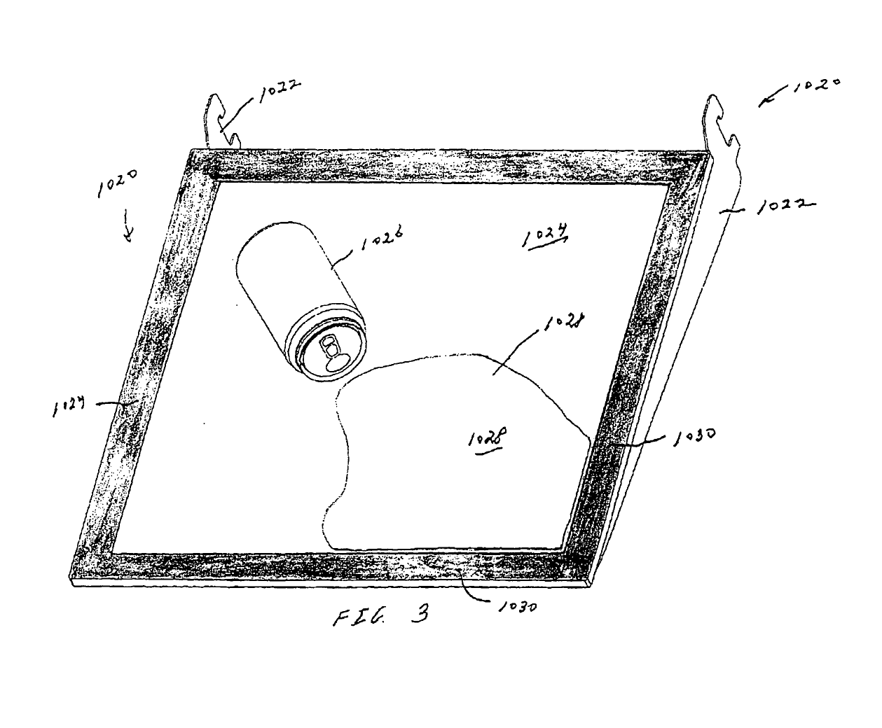

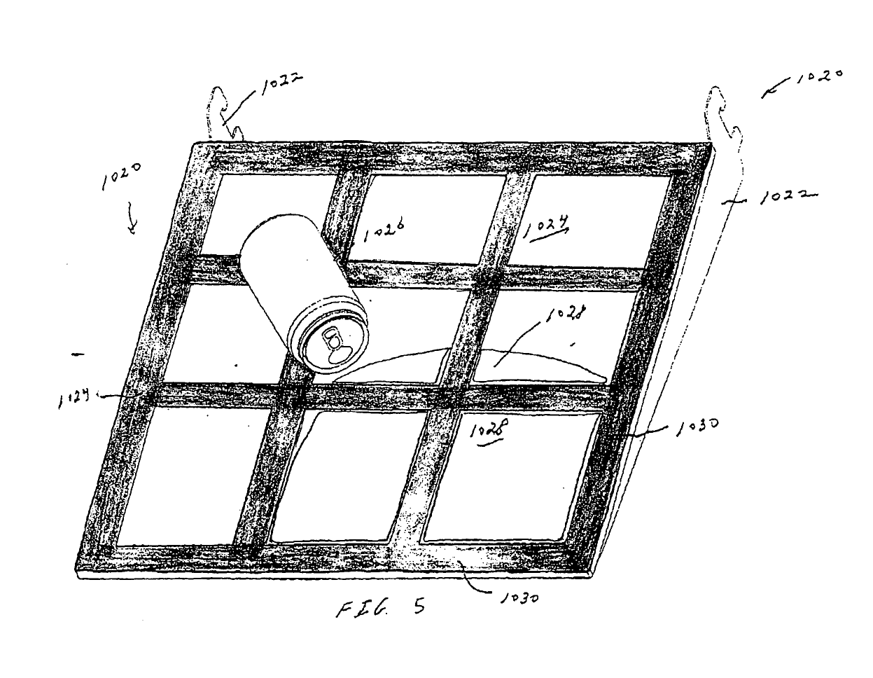

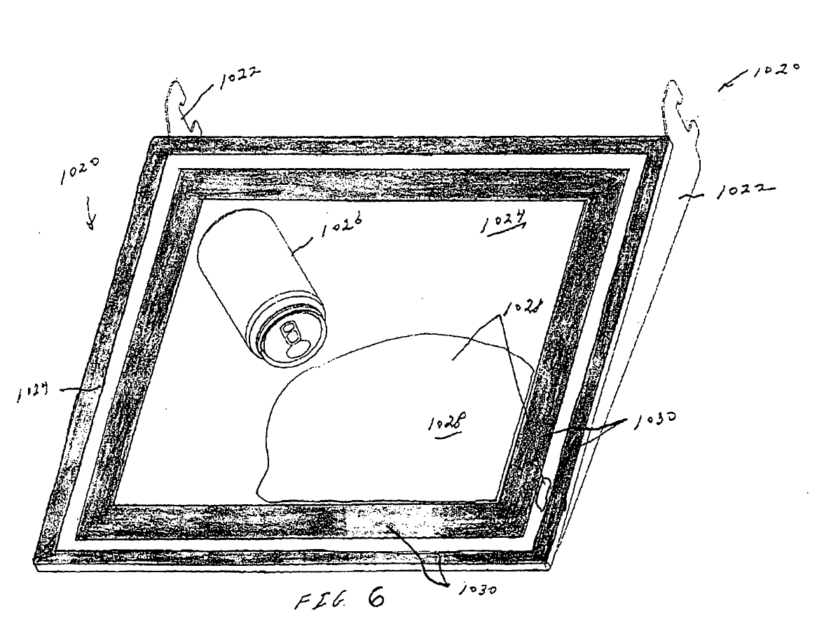

In such preferred embodiments of the invention, refrigerator shelving is provided with a spill containment pattern which may consist of a hydrophobic surface in the pattern of a frame-like border, which defines the boundaries of a single spill containment area therein. The pattern may be a frame-like border which extends along the perimeter of the shelf's top surface (FIG. 3), or it may be spaced from the perimeter and encompass a smaller portion of the top surface, and may include an outer border with a final spill catch area between the inner and outer border (FIG. 6). It may consist of a hydrophobic surface in a grid-like pattern, which pattern defines the boundaries of several spill containment areas therein (FIG. 5). Other variations may occur to those skilled in the art in the practice of the present invention.

A preferred embodiment shelf may be incorporated into a shelving assembly with a shelf-supporting mechanism, such as a bracket, and a shelf, which is capable of supporting articles on its top surface. The disclosure provided herein relates to the shelf portion of the assembly, which can be used with brackets of various designs, including various types of brackets as known in the art.

The shelf may consist of metal, glass, plastic, other suitable material, or a combination of any of the foregoing, and has a hydrophobic surface which is generally in the plane of the top surface of the shelf and which is arranged in a spill containment pattern to provide a spill containment feature on the top surface of the shelf as illustrated in FIGS. 3-6. The majority of the surface area of the top surface of the shelf is not hydrophobic in nature, and spilled liquids are contained on these non-hydrophobic spill containment areas by the hydrophobic surfaces. The shelves described herein can be adapted for use as a refrigerator shelves.

A hydrophobic or super hydrophobic surface treatment may be applied to the shelf's top surface to create the hydrophobic surface described herein in a variety of methods which are known in the art, and any surface coatings may be used which are known to be hydrophobic or are known to make the surface of the shelf hydrophobic. The hydrophobic surface described herein is not limited to any specific hydrophobic or super hydrophobic surface treatment, and any method of making the surface of the shelf hydrophobic may be employed.

More specifically, according to the preferred embodiments, there are several known hydrophobic compounds which may be used with any of the methods described in the prior art. Some of the commonly recognized hydrophobic compounds include: fluorocarbons; fluoroalkyl silanes; fluoroalkoxy silanes; and fluoroalkyl alkyl silanes. Any such hydrophobic compounds or a mixture thereof can be used to create the hydrophobic surfaces described herein, and other applicable hydrophobic compounds will be apparent to those skilled in the art. It is believed that tridecafluoro-1,1,2,2-tetrahydrooctyl trichlorosilane provides a good example of a suitable hydrophobic compound.

More specifically, and further in accordance with the preferred embodiments described herein, methods of creating the hydrophobic surface may include, without limitation: (1) application of a hydrophobic compound to the top surface using any known application technique such as spraying; brushing; wiping; dipping; solvent casting; flow coating; curtain coating; roller coating; spin coating; printing; screen printing; ink jet printing; vacuum coating; magnetic field-assisted cathodic sputtering; plasma deposition; plasma magnetron deposition; plasma or atmospheric CVD; powder or liquid pyrolysis; atomization or chemical vapor deposition; electrophoretic deposition; cross-linking processes; etc.; (2) roughening the surface to be made hydrophobic using various methods (sanding, etching, e.g., acid etching, applying ceramic frit to bind particles on the surface; otherwise binding particles to the surface, etc.) and then applying a hydrophobic compound to the roughened surface; (3) providing a coating of hydrophobic particles on the surface; (4) using sol-gel deposition to apply a hydrophobic compound to the surface, either on top of or within the matrix of the sol-gel; (5) applying a metal oxide primer with an integrated or separate hydrophobic compound; (6) applying a hydrophobic compound comprising a variety of molecular chain lengths to create a coating with surface irregularities; (7) adhering a thin material, such as a tape of thin glass or plastic which has been made hydrophobic to the surface; (8) applying a ceramic frit, with or without structure forming particles as in (2) above, and then applying a hydrophobic compound over the cured fit.

The hydrophobic surface treatments described herein can be cured according to a number of different methods, if curing is required by the surface preparation or the hydrophobic compound, including without limitation: heating; UV radiation; VUV radiation; electron beam irradiation; ionizing radiation; laser; IR; and thermal radiation.

One preferred embodiment of the shelf comprises a glass or tempered glass shelf which is printed, e.g., screen printed, with a ceramic frit material, over which a hydrophobic coating is applied. In accordance with various aspects of the invention, the ceramic frit material can include finely ground glass particles. These particles may be mixed with inorganic or organic pigments, so as to yield a desired color. The coated glass can then be heated to around 1150° F. This heat treatment will cause the ceramic frit to fuse to the glass surface. It is believed that this coating can be characterized as being nearly as hard and tough as the glass itself. Also, the coated glass with the ceramic frit material is durable, and resists chipping, peeling, fading, and scratching. In addition, the ceramic frit material is substantially resistant to most chemicals.

In one embodiment, the ceramic fit can include some micro-scale additive particles which will remain unmelted at the temperature at which the frit is sintered, as described for example in U.S. Pat. Nos. 4,591,530 to Lui, 6,872,441 and 6,800,354 to Baumann, and 5,324,566 and 5,437,894 to Ogawa. The frit is printed in the pattern of a frame-like border at or near the outer perimeter of the shelf's top surface. The shelf with the printed frit is then heated to a temperature above the melting point of the primary components of the frit material, but below the melting point of the glass shelf, for a time sufficient to sinter the frit so that it is bonded to the top surface of the shelf. (The time and temperature required to sinter the frit will vary based on the materials chosen for the frit.) A hydrophobic solution, such as a 1% solution of Tridecafluoro-1,1,2,2-Tetrahydrooctyl Trichloro Silane, a perfluoroalkyl alkyl silane, in hexane, is then applied to the area which has been coated with the frit using any known method such as wiping the solution onto the fit. The hydrophobic solution is then cured by heating it or exposing it to controlled humidity for a period of time. The method described herein will produce a hydrophobic surface that is in a continuous border around the perimeter of the shelf's top surface which will operate as a spill containment feature.

One advantage of using a ceramic frit material to prepare the surface of the shelf for coating with the hydrophobic solution as described herein, in addition to improving the durability of the hydrophobic surface, is that frit material is commercially available in multiple colors and can be printed in a manner which allows for the inclusion of designs, company names or logos in the surface area where the frit material is applied to the shelf.

In accordance with the preferred embodiments, the hydrophobic surface provides a spill containment surface which prevents spilled liquids from leaking off of the shelf's top surface. The hydrophobic surface repels liquids, causing them to collect in the non-hydrophobic region or regions of the shelf. The hydrophobicity of the hydrophobic surface is sufficient to repel a spilled liquid and prevent it from crossing onto or over the hydrophobic surface and therefore forces the spilled liquid to bead up or puddle up on the non-hydrophobic regions of the shelf due to the surface tension of the liquid. Thus, the hydrophobic surface is capable of containing spills without the use of a barrier lip or barrier edging used in prior art spill containment assemblies which act as a “dam” for the spilled liquid.

The reference to the fact that the hydrophobic surface is generally in the plane of the top surface of the shelf is intended to include surfaces and surface treatments, all or a portion of which may extend a small distance above the level of the top surface of the shelf which is not readily noticeable to the naked eye. For example, as described in greater detail above, the hydrophobic surface may be a hydrophobic coating, or a combination of a layer of ceramic frit and a hydrophobic coating on the ceramic fit. Such layers typically have a thickness of from about 0.001 microns to about 250 microns.

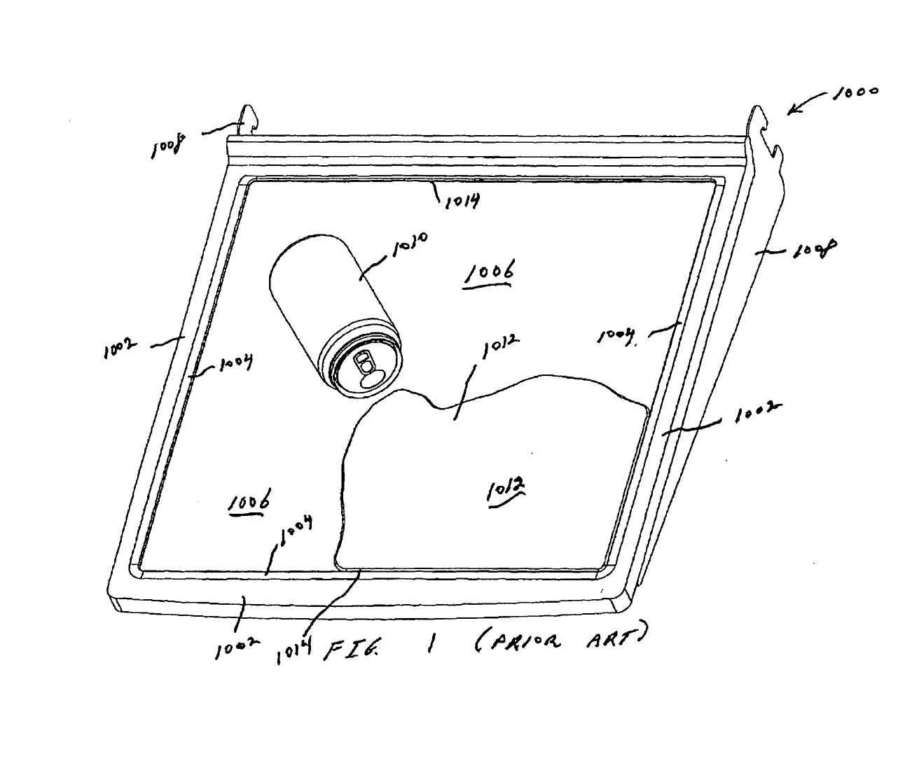

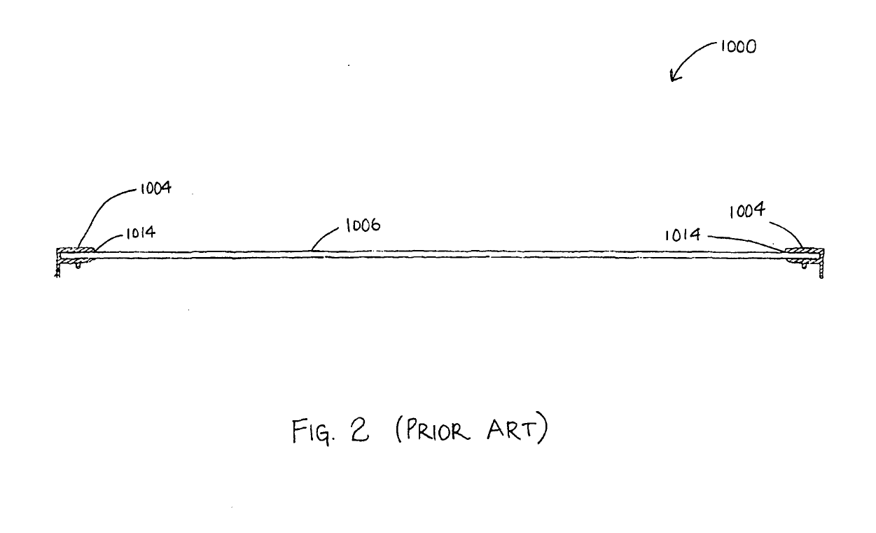

A visual perspective of situations involving liquid spillage is illustrated in FIGS. 1 and 2 which illustrate a prior art shelving assembly 1000. With reference to FIG. 1, the assembly 1000 is shown in fairly simplistic format. The assembly 1000 may include a number of other components, including elements such as shelf supports, which are not relevant to the disclosure provided herein. Specifically, the assembly 1000 includes a frame 1002 which is rectangular in configuration and surrounds and is secured to an inner plastic rim 1004. The plastic rim 1004 is also a rectangular configuration. The plastic rim 1004 is utilized to encapsulate a shelf panel 1006. The shelf panel 1006 could be constructed of glass or similar materials. The frame 1002, plastic rim 1004 and shelf panel 1006 are supported on a pair of opposing side plates 1008.

To illustrate the concepts of liquid spillage, a soda can 1010 is illustrated as being left on its side on the upper surface of the shelf panel 1006. The soda can 1010 has spilled liquid which is shown as liquid 1012 on a portion of the shelf panel 1006. The visible edge of the shelf panel 1006 located on its upper surface at the intersection of the perimeter of the plastic rim 1004 may include a sealed edge 1014. As previously described herein, the sealed edge 1014 may merely include some type of a sealing adhesive or, alternatively, a silicone material or the like. In this manner, an attempt is made to essentially provide a raised physical barrier that is sealed to the shelf panel 1006 to seal the spilled liquid 1012 from spillage off of the shelf panel 1006.

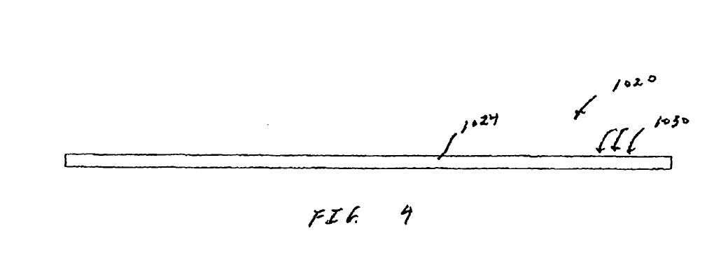

A preferred embodiment shelf assembly 1020 is illustrated in FIGS. 3 and 4. In accordance with the preferred embodiments described herein, the shelf 1020 is characterized as having a hydrophobic surface 1030 (shown shaded) in a spill containment pattern on the top surface of the shelf to provide the spill containment functions. In FIGS. 3 and 4, the spill containment pattern of the hydrophobic surface 1030 consists of a frame-like border around the outer perimeter of the top surface of a shelf 1024. As with other known assemblies, the shelf assembly 1020 may also include side plates 1022. A soda can 1026 turned on its side is shown on the surface of the shelf 1024, and spilled liquid from the soda can 1026 is illustrated as liquid 1028.

FIG. 3 also illustrates the concept that the hydrophobic surface 1030 will form a spill containment barrier for the spilled liquid 1028. In this manner, the spilled liquid 1028 is prevented from spilling downwardly onto other surfaces below the shelf, and the spilled liquid 1028 is contained on the top surface of the shelf 1020. Further, the spilled liquid 1028 is also prevented from seeping into cracks or crevices in a manner where substantial bacteria, mold, and other undesirable materials can form. In particular, and in accordance with the preferred embodiments, it should be noted that components such as a plastic rim (or even a frame) may be completely unnecessary with the use of the hydrophobic surface 1030 to provide the spill containment feature.

In addition to the embodiment shown in FIGS. 3 and 4, the hydrophobic surface 1030 may be provided on the top surface of the shelf 1024 in a grid-like spill containment pattern as described herein and as shown in FIG. 5. FIG. 6 shows yet another variation in which a first hydrophobic surface border is spaced along the perimeter of the shelf, and a second hydrophobic surface border 1030 is spaced inwardly slightly from the edge of the shelf. The second hydrophobic surface border could be used without the first, but is advantageously used in combination with the first, with a containment area being located between the two borders. The second hydrophobic surface border thus defines an inner spill containment area, and the space between the two borders defines an outer spill containment area, to capture any spill overflow which might escape over the inner border. These and other variations in the spill containment pattern can be made without departing from the spirit and scope of the novel concepts of the preferred embodiments.

The hydrophobic surface arranged in a spill containment pattern in accordance with the preferred embodiments described herein eliminates the need for plastic encapsulation material to create a spill containment barrier. Accordingly, the shelves produced in accordance with the preferred embodiments described herein utilize relatively less material than prior art spill-containing shelves. Further, the shelves described herein have no need for silicone sealants to create a spill containment barrier. With the exception of the hydrophobic tape embodiment, they have no need for adhesives to create a spill containment barrier. Elimination of the need for these materials also results in relatively less use of material. Further, using the hydrophobic surfaces arranged in a spill containment pattern in accordance with the preferred embodiments eliminates the need for formed lips or ridges on the shelf's top surface, which reduces the amount of material used and the complexity of manufacturing, and, therefore, reduces the manufacturing cost.

Elimination of plastic encapsulation and sealants from the design of the shelf member also eliminates a potential source of failure or leakage since the sealants and plastic encapsulation may have cracks or crevices where they join with the shelf member in which organic or inorganic materials may become entrapped and involve a bond area to the shelf member which may eventually leak. Still further, by eliminating the space taken up by plastic encapsulation, sealants, adhesives, or formed lips and ridges, the relative amount of usable shelf space is increased on a shelf in accordance with the preferred embodiments described herein. Still further, the use of hydrophobic surfaces arranged in a spill containment pattern retains an amount of liquid comparable to that retained by prior art shelves having spill containing dam features, without the necessity of using the dams.

As earlier described herein, the hydrophobic surface arranged in a spill containment pattern in accordance with the preferred embodiments provides a spill containment feature which prevents spilled liquids from leaking off of the top surface of the shelf, and shelves in accordance with the preferred embodiments can be used in various applications, such as refrigerator shelves.

It will be apparent to those skilled in the pertinent arts that other embodiments of shelving members in accordance with the invention may be designed. That is, the principles of shelving members in accordance with the invention are not limited to the specific embodiments described herein. For example, shelf members or other support surfaces having a hydrophobic spill containment surfaces could be used in various settings, such as shelving in other settings, tables, countertops or the like, and are not limited to use as refrigerator shelves.

Further, it will be apparent to those skilled in the pertinent art that any method which may be used for creating a hydrophobic surface arranged in a spill containment pattern in substantially the same plane as the top surface of the shelf member is within the scope of the invention described herein, even if such method requires the use of multiple pieces to manufacture the shelf member. For example, a frame of hydrophobic material may be bonded to the shelf member such that it forms a continuous border which is generally in the same plane as the top surface of the shelf. Accordingly, it will be apparent to those skilled in the art that modifications and other variations of the above-described illustrative embodiments of the invention may be effected without departing from the spirit and scope of the novel concepts of the invention.

1. A shelf or the like comprising; a support having a generally flat top surface which is capable of supporting articles which may be placed on said support; a hydrophobic surface arranged in a spill containment pattern generally in the plane of said top surface; wherein the majority of the surface area of said top surface of the support is not hydrophobic, thereby providing one or more non-hydrophobic spill containment areas bounded by said hydrophobic surfaces of said spill containment pattern.

2. A shelf or the like as described in claim 1 wherein said spill containment pattern is a continuous border which defines a single non-hydrophobic spill containment area within said border.

3. A shelf or the like as described in claim 2 wherein said spill containment pattern is a continuous border located near the perimeter of the support's top surface.

4. A shelf or the like as described in claim 3 wherein said spill containment pattern is located along the perimeter of the support's top surface.

5. A shelf or the like as described in claim 1 wherein said spill containment pattern comprises two spaced continuous borders, a first being a continuous border located along the perimeter of the support's top surface, and the second being a continuous border spaced inwardly from said first border, such that the second border circumscribes an inner spill containment area, and the first and second borders together define between them an outer spill containment area for containing overflow from said inner containment area.

6. A shelf or the like as described in claim 1 wherein said spill containment pattern is in the form of a grid pattern on the support's top surface and wherein said grid pattern defines more than one non-hydrophobic spill containment area on the support's top surface.

7. A shelf or the like as described in claim 1 which is adapted for use as a refrigerator shelf.

8. A shelf or the like as described in claim 1 wherein said support is comprised of a material chosen from the group consisting of glass, plastic, metal and combinations thereof.

9. A shelf or the like as described in claim 8 wherein the support is transparent.

10. A shelf or the like as described in claim 9 wherein the support is glass.

11. A shelf or the like as described in claim 8 wherein the hydrophobic surfaces are transparent.

12. A shelf or the like as described in claim 8 wherein at least some portion of the hydrophobic surfaces are colored.

13. A shelf or the like as described in claim 12 wherein the hydrophobic surfaces contain a colored portion in a form chosen from the group consisting of a pattern, a company name, a company logo and combinations thereof.

14. A shelf or the like as described in claim 1 wherein the hydrophobic surface comprises:
a ceramic frit layer adjacent to the support's top surface; and
a hydrophobic compound coated over the surface of the ceramic frit layer.

15. A shelf or the like as described in claim 14 wherein said ceramic frit layer contains additive particles that create roughness in the top surface of the ceramic frit layer.

16. A shelf or the like as described in claim 14 wherein at least a portion of said ceramic frit layer is colored.

17. A shelf or the like as described in claim 1, wherein said hydrophobic surface comprises a hydrophobic coating over a roughened area in the surface of said support.

18. (canceled)

19. A shelf or the like as described in claim 17 wherein said roughened area is made by binding particles to surface of the support.

20. A shelf or the like as described in claim 1 wherein said hydrophobic surface comprises a coating of hydrophobic particles on the surface of said support.

21. A shelf or the like as described in claim 1 wherein said hydrophobic surface comprises a hydrophobic compound applied over or within the matrix of a cured sol gel composition.

22. A shelf or the like as described in claim 1 wherein said hydrophobic surface comprises a metal oxide primer with an integrated hydrophobic compound.

23. A shelf or the like as described in claim 1 wherein said hydrophobic surface comprises a hydrophobic coating applied over a metal oxide primer.

24. A shelf or the like as described in claim 1 wherein said hydrophobic surface comprises a hydrophobic compound comprising a variety of molecular chain lengths to create a coating with surface irregularities.

25. A shelf or the like as described in claim 1 wherein said hydrophobic surface comprises a tape of thin material with a hydrophobic surface.

26. A method of containing liquid spills on shelves comprising:
providing a support or the like having a generally flat top surface which is capable of supporting articles which may be placed on said support;
applying a hydrophobic surface arranged in a spill containment pattern generally in the plane of said top surface;
leaving the majority of the surface area of said top surface of the support member non-hydrophobic, thereby providing one or more non-hydrophobic spill containment areas bounded by hydrophobic surfaces of said containment pattern.

27. A method of manufacturing a shelf or the like capable of containing liquid spills thereon comprising:
providing a support having a generally flat top surface which is capable of supporting articles which may be placed on said support;
applying a hydrophobic surface arranged in a spill containment pattern generally in the plane of said top surface;
leaving the majority of the surface area of said top surface of the support member non-hydrophobic, thereby providing one or more non-hydrophobic spill containment areas bounded by hydrophobic surfaces of said containment pattern.

28. A method of manufacturing a shelf or the like as described in claim 27 wherein step of applying a hydrophobic surface comprises:
applying a ceramic frit to the top surface of the support in a spill containment pattern;
sintering the ceramic frit to the top surface of the support;
applying a hydrophobic compound to the sintered ceramic frit; and
curing the hydrophobic compound.
